(19) United States
(12) Patent Application Publication
(10) Pub. No.: US 2024/0056177 A1
(43) Pub. Date: Feb. 15, 2024

(54) ESTIMATION OF A COMMUNICATION LINK PARAMETER FOR USE IN A NON-TERRESTRIAL NETWORK

(71) Applicant: Sony Group Corporation, Tokyo (JP)

(72) Inventors: Fredrik RUSEK, Eslöv (SE); Olof ZANDER, Södra Sandby (SE); Kun ZHAO, Malmö (SE); Erik BENGTSSON, Eslöv (SE); Jose FLORDELIS, Lund (SE)

(21) Appl. No.: 18/267,049

(22) PCT Filed: Dec. 10, 2021
(86) PCT No.: PCT/EP2021/085324

§ 371 Date: Jun. 13, 2023

(30) Foreign Application Priority Data
Jan. 8, 2021 (SE) 2150007-9

(51) Int. Cl. H04B 7/195; H04W 56/00

(52) U.S. Cl. CPC H04B 7/195; H04W 56/005; H04W 84/06

(57) ABSTRACT

A method carried out in a UE (1) for estimation of a parameter of a communication link, such as Timing Advance, for use in communication with an orbiting satellite-based access node (141) of a non-terrestrial network (130). The method comprises determining, at repeated occasions, a time of reception (Tₖ) in the UE of a reference signal which is transmitted with a predetermined period (τ_{P}) from the access node. A value of the parameter is calculated based on a position (51,52) which satisfies a spatial condition for the UE, which spatial condition is given by a propagationtime difference (Δₖ) of the reference signal between said occasions (Tₖ, Tₖ₊₁).

### TECHNICAL FIELD

This disclosure relates to solutions for use in user equipment configured to communicate with a non-terrestrial network. Specifically, solutions are provided for estimation of a parameter of a communication link for use in communication with an orbiting satellite-based access node, such as for estimating an initial timing advance value.

### BACKGROUND

In a cellular radio communications system, wireless devices may act as mobile terminals for operation by radio communication with base stations, or access nodes, of a wireless communications network. It may be noted that the most common term for wireless devices configured to operate by wireless communication is User Equipment (UE), a term which will also be used herein going forward. The cellular communications networks may e.g. be configured and operated under the specifications provided under the 3rd Generation Partnership Project (3GPP).

Further releases of the 3GPP system specifications will provide improvements in the field of Non-Terrestrial Networks (NTN), which means access networks including satellite-based access nodes, or TRPs (Transmission and Reception Points). NTN has the target to offer connectivity with global coverage. The NTN may comprise a grid of satellites serving UEs on the ground.

When a UE is connecting to the NTN, various communication link parameters may require particular attention when a communication channel is to be set up. In particular, this relates to parameters of a communication link, for use in communication with the NTN, such as for establishing a connection with the NTN. The reason for this is that distances between the UE and the satellite-based access nodes may be considerably larger than in the traditional terrestrial case. Moreover, the speed of the satellite, and the resulting change in distance, may pose further challenges.

One example of such a parameter is Timing Advance (TA). Simply put, TA is a negative offset applied at the UE, between the start of a received downlink subframe and a transmitted uplink subframe. This offset at the UE is necessary to ensure that the downlink and uplink subframes are synchronized at the access node. Once the UE is in connected mode, the access node may continuously estimate TA and send TA commands to the UE if correction is required. However, when the UE is disconnected from the network, such as in RRC Idle or inactive, an initial TA must first have to be estimated by the UE. The access node transmits one or more downlink synchronization signals, such as within a Synchronization Signal Block (SSB). Upon initial access, the UE responds to the synchronization signal with a preamble on a Physical Random Access Channel (PRACH). However, if the TA is not appropriately set, then the PRACH response will not be aligned with a corresponding PRACH slot at the satellite-based access node, and initial connection fails.

Another example of a parameter that may require attention in NTN is Doppler compensation. Since the satellite is typically moving at a very high speed in its trajectory, the UE may be required to calculate frequency pre-compensation to counter shift the Doppler experienced on the link to the satellite-based access node, to properly tune or select a frequency used for communication.

Calculating the TA in a UE operating in an NTN requires a single input value, namely the distance between the satellite and the UE. Then a scaling by the speed-of-light renders the TA. A similar requirement applies to the Doppler estimation, which relates to the satellite radial movement with respect to the UE, which can be determined based on the change of the distance between the satellite and the UE. For this purpose, it has been agreed in the 3GPP to specify that the UE should at least be able to estimate its position via global navigation satellite systems (GNSS), and then receive the serving satellite's position based on Ephemeris. However, this solution suffers from drawbacks. First of all, it requires a GNSS receiver in the UE. For low-cost UEs, this could constitute a considerable part of its total cost and increases the technical complexity and antenna requirement on the UE, as well as potentially introducing a dependency of the 3GPP standard toward other standardization bodies. Moreover, receiving a position via GNSS can take a considerable amount of time, up to 15 minutes for a UE just turned on. In the context of initial access, the UE is not connected and can therefore not use assisted GNSS but relies entirely on GNSS signals to determine its position.

Therefore, it can be concluded that there is a need for an alternative solution for estimating communication parameters in a UE for use in initial access to an NTN. Specifically, a solution is desired which overcomes at least some of the listed drawbacks. An aspect of this is a need to engineer a solution for determining the parameters of a communication link which does not rely upon a built in GNSS receiver in the UE.

### SUMMARY

In view of the above, a solution is provided for estimating a parameter of a communication link, which may be used in a UE at initial access to an NTN. In various examples, this relates to calculating an initial TA, and in some examples, this relates to calculating a frequency pre-compensation to counter Doppler shift.

The proposed solution is set out in the independent claims. According to one aspect, the solution provides a method carried out in a UE for estimation of a parameter of a communication link for use in communication with an orbiting satellite-based access node of a non-terrestrial network, the method comprising:
determining, at repeated occasions, a time of reception in the UE of a reference signal which is transmitted with a predetermined period from the access node; and
calculating a value of the parameter based on a position which satisfies a spatial condition for the UE, which spatial condition is given by a propagation time difference of the reference signal between said occasions.

The proposed solution provides a way of estimating the communication parameter, such as TA or Doppler pre-compensation, without relying on GNSS. This provides inter alia the technical effect of not requiring a GNSS receiver in the UE, which reduces technical complexity and cost. Moreover, the proposed solution offers the opportunity of reducing time for estimating the parameter and thus, for the initial access as a whole, rendering a shorter access time. Furthermore, the proposed solution relies on reception of reference signals from a single access node, without requiring reception from further access nodes, which further reduces the complexity of controlling a signal receiver in the UE.

### BRIEF DESCRIPTION OF THE DRAWINGS

Various examples and use cases of the proposed solution will be described below with reference to the accompanying drawings, in which:

FIG. 1 illustrates a wireless network including a non-terrestrial access network, in which network the proposed solutions may be carried out;

FIG. 2 provides an illustrative representation of satellite positions over a geographical area at an instant of time, usable for understanding the proposed solution;

FIG. 3 schematically illustrates functional elements of a UE configured to carry out various aspects of the proposed solution;

FIG. 4 schematically illustrates a basis for determining a spatial condition for the UE given by a propagation time difference of the reference signal between different occasions, in accordance with various examples;

FIG. 5 schematically illustrates an example of a planar projection of how a position is determined which satisfies the spatial condition determined based on a plurality of occasions;

FIG. 6 schematically illustrates various satellite positions of the access node along its trajectory;

FIG. 7 schematically illustrates the spatial condition based on two occasions of reception of a reference signal from the access node, as determined according to an example of the proposed solution;

FIG. 8 schematically illustrates the spatial condition based on three occasions of reception of a reference signal from the access node, as determined according to an example of the proposed solution; and

FIG. 9 schematically illustrates a planar projection of the spatial conditions of FIG. 8, where two points where those conditions intersect are identified.

### DETAILED DESCRIPTION

In the following description, for purposes of explanation and not limitation, details are set forth herein related to various examples. However, it will be apparent to those skilled in the art that the present invention may be practiced in other examples that depart from these specific details. In some instances, detailed descriptions of well-known devices, circuits, and methods are omitted so as not to obscure the description of the present invention with unnecessary detail. The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented and are thus machine-implemented. In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) (ASIC), and (where appropriate) state machines capable of performing such functions. In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

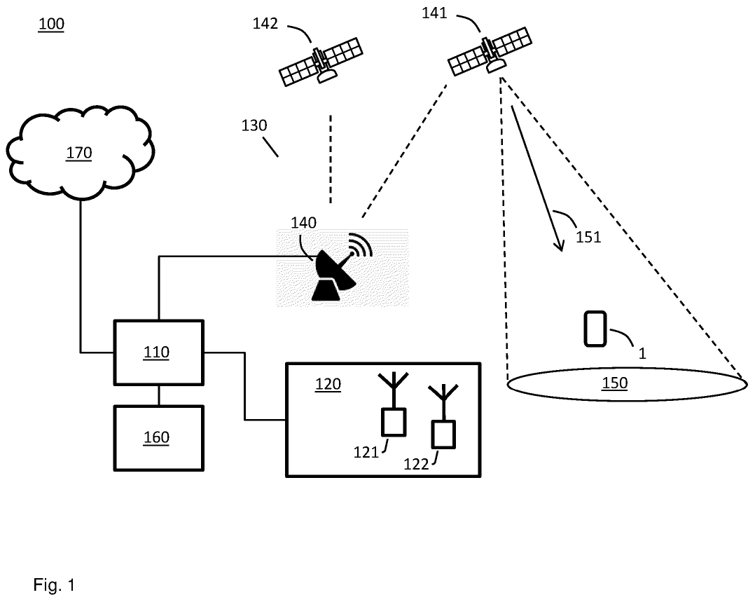

FIG. 1 schematically illustrates a wireless communication system, providing an example of a scenario in which the solutions provided herein may be incorporated. The wireless communication system includes a wireless network 100, and a UE (or wireless device) 1 configured to wirelessly communicate with the wireless network 100. The wireless network 100 comprises a core network 110, which is connected to other communication networks 170. The wireless network 100 further comprises one or more access networks 120, 130, usable for communication with UEs of the system. Such access networks may comprise a terrestrial network 120 comprising a plurality of access nodes or base stations 121, 122, configured to provide a wireless interface for, inter alia, the UE 1. The base stations 121, 122 may be stationary or mobile. Each base station, such as the terrestrial base station 121, 122, comprises a point of transmission and reception, referred to as a Transmission and Reception Point (TRP), which coincides with an antenna of the respective base station. Logic for operating the base station may be configured at the TRP or at another physical location. The access network may further comprise a non-terrestrial network (NTN) 130. The NTN 130 may comprise one or more satellites 141, 142, configured to transmit signals 151 associated with a cell of the wireless network 100 within a coverage area 150. A ground station 140 of the NTN 130 may be connected to the core network 110, and wirelessly connected to one or more of the satellites 141, 142. Each satellite 141, 142 may be seen as one NTN TRP for the respective NTN base station or access node, realizing an NTN cell, whereas logic and hardware for each such non-terrestrial network base station may be completely or partly configured in the ground station 140 or in other nodes of the access network. A positioning node 160 may be connected to the core network 110 and be configured to calculate a UE position based on received measurement data.

The UE 1 may be any device operable to wirelessly communicate with the network 100 through the base stations 121, 122 and/or the NTN TRPs 141, 142, such as a mobile telephone, computer, tablet, a M2M device or other. The UE 1 can be configured to communicate in more than one beam. Configuration of beams in the UE 1 may be achieved by a spatial filter realized by using an antenna array configured to provide an anisotropic sensitivity profile to transmit radio signals in a particular transmit direction.

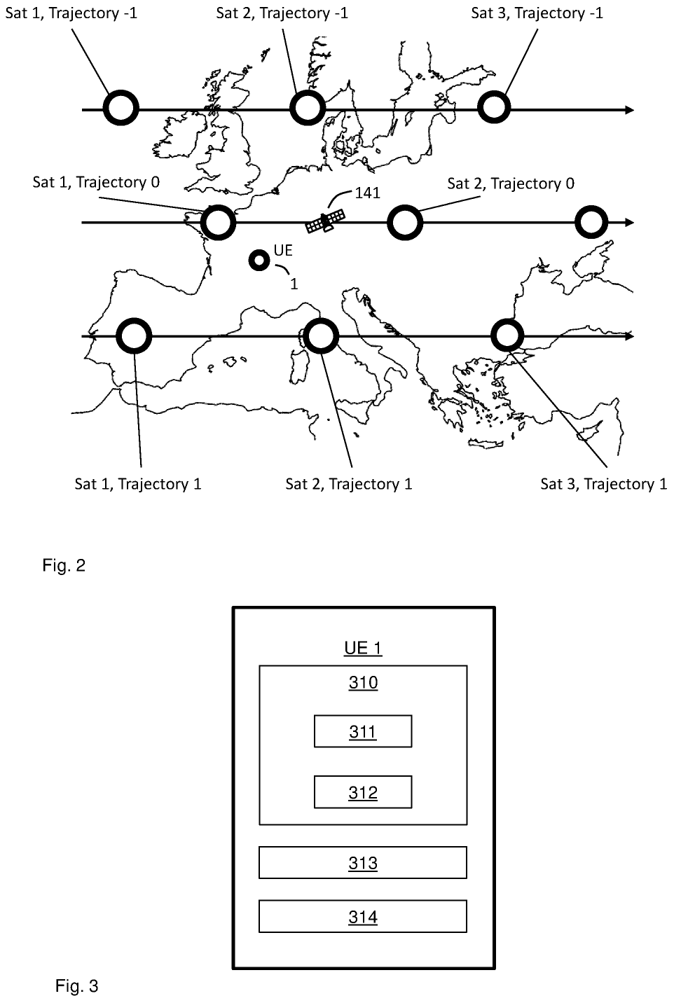

FIG. 2 schematically illustrates a layout of various satellites, comprising NTN TRPs, of the NTN 130 at a given instance in time. Three satellite trajectories (indexed −1, 0, and 1 for simplicity) are shown, and for each trajectory three satellites (indexed 1, 2 and 3) are indicated. The black dot identifies the actual position of the UE 1. It may be noted that, in reality, trajectories need not be parallel but are drawn parallel here for simplicity. This has no implication for the technical content of the solutions proposed herein.

From the drawing of FIG. 2, assuming that the NTN TRPs provide moving cells which sweep across Earth, it can be seen that, currently, the UE 1 receives the strongest signals from satellite Satl on Trajectory 0. According to the respective Ephemeris of the satellites, it takes a certain amount of time for the satellite (of any trajectory) to move from the position of Sat 1 to the position of Sat 2 on the same trajectory, such as approximately 1 minute.

For the most part, the present disclosure provides a description of the proposed solution in the context of TA estimation. However, it shall be noted that the corresponding considerations and calculations may be used also for Doppler frequency pre-compensation in various examples.

The proposed solution is based on the notion that there is a relationship between UE positioning and estimation of a parameter of a communication link for use in the UE for communication with the NTN TRP, such as TA (or Doppler frequency pre-compensation). If the UE position relative to the satellite is known, then TA estimation is possible. However, the contrary is not true. Further, for TA estimation, there can be ambiguity in the UE position, namely that if only the distance from the satellite is known, this nevertheless suffices for TA estimation. This last point is important: to facilitate TA estimation, it suffices to perform a low accuracy, or incomplete, version of positioning that merely finds the distance to the satellite. The proposed solution draws upon this and identifies a simple method that requires only a single satellite. In view of FIG. 2, the solution will be described with reference to a satellite, or NTN TRP, 141 at trajectory 0, as it travels in connection range of the UE 1. Note that this is not an instance of normal positioning since the positional estimate obtained in the context of the proposed solution is ambiguous. In that sense, the solution may be provided as a positioning method sufficient for TA (or Doppler frequency pre-compensation) estimation.

Before discussing further details and aspects of the proposed method, functional elements for the UE 1, configured to carry out the proposed solution, will be briefly discussed.

FIG. 3 schematically illustrates an example of the UE 1 for use in a wireless network 100 as presented herein, and for carrying out various method steps as outlined.

The UE 1 comprises a radio transceiver 313 for communicating with other entities of the radio communication network 100, such as the base station TRPs 121, 122, 141, 142, in different frequency bands. The transceiver 313 may thus include a radio receiver and transmitter for communicating through at least an air interface.

The UE 1 may further comprise an antenna system 314, which may include one or more antenna arrays. In various examples the UE 1 is configured to operate with a single beam, wherein the antenna system 314 is configured to provide an isotropic sensitivity to transmit radio signals. In other examples, the antenna system 314 may comprise a plurality of antennas for operation of different beams in transmission and/or reception.

The UE 1 further comprises logic circuitry 310 configured to communicate data, via the radio transceiver, on a radio channel, to the wireless communication network 100.

The logic circuitry 310 may include a processing device 311, including one or multiple processors, microprocessors, data processors, co-processors, and/or some other type of component that interprets and/or executes instructions and/or data. The processing device 311 may be implemented as hardware (e.g., a microprocessor, etc.) or a combination of hardware and software (e.g., a system-on-chip (SoC), an application-specific integrated circuit (ASIC), etc.). The processing device 311 may be configured to perform one or multiple operations based on an operating system and/or various applications or programs.

The logic circuitry 310 may further include memory storage 312, which may include one or multiple memories and/or one or multiple other types of storage mediums. For example, the memory storage 312 may include a random access memory (RAM), a dynamic random access memory (DRAM), a cache, a read only memory (ROM), a programmable read only memory (PROM), flash memory, and/or some other type of memory. The memory storage 312 may include a hard disk (e.g., a magnetic disk, an optical disk, a magneto-optic disk, a solid state disk, etc.). The memory storage 312 is configured for holding computer program code, which may be executed by the processing device 311, wherein the logic circuitry 310 is configured to control the UE 1 to carry out any of the method steps as provided herein. Software defined by said computer program code may include an application or a program that provides a function and/or a process. The software may include device firmware, an operating system (OS), or a variety of applications that may execute in the logic circuitry 310.

Obviously, the UE 1 may include other features and elements than those shown in the drawing or described herein, such as a power supply, a casing, a user interface, sensors, etc., but are left out for the sake of simplicity.

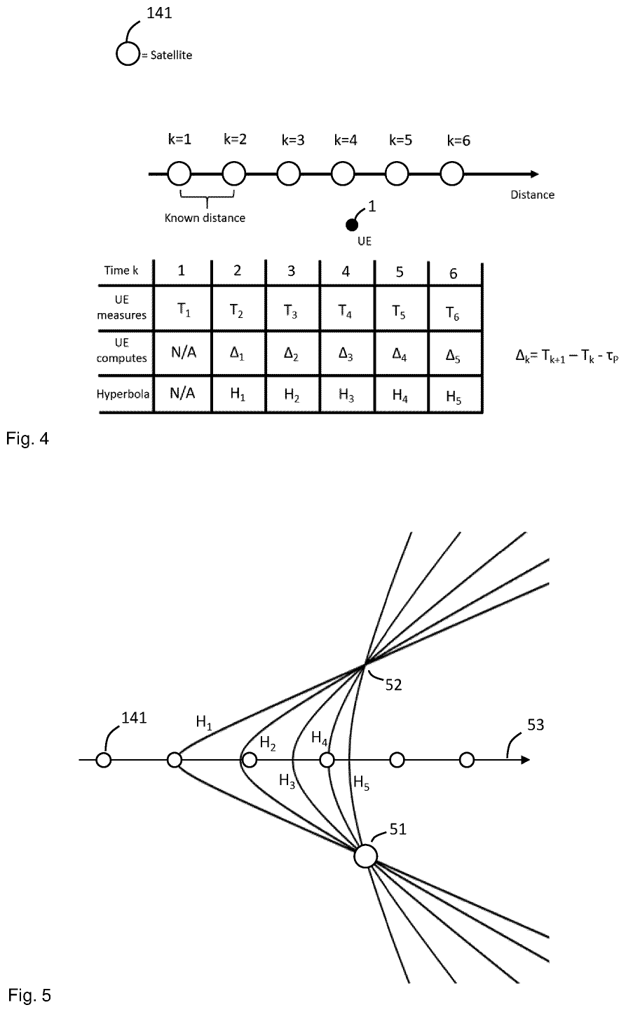

The concept and various features of the proposed solution will now be described with reference to FIGS. 4 and 5.

The satellite-based access node or TRP 141, here referred to as satellite 141 for the sake of simplicity, moves along its trajectory, such as trajectory 0 of FIG. 2. The satellite is configured to periodically transmit reference signals, with known period Tp. The reference signal may for example be a Positioning Reference Signal (PRS), or Primary/Secondary Sync Signals (PSS/SSS), or other. The period τ_{P} may be given as the periodicity of the SSB. In other examples, the reference signal is transmitted with a different, longer period τ_{P}, such as only every n^{th} SSB period, where n is 2 or more. In an alternative scenario, the reference signal may be transmitted in bursts comprising a plurality of reference signal transmissions with a certain period τ_{P}, with a burst periodicity of e.g. 1 s, according to a configuration known to the UE 1. The period τ_{P} may be known to the UE 1 based on specification, or pre-configuration based on obtained system information. The period τ_{P} may e.g. be 5 ms, 10 ms, 20 ms or other. The reference signal will thus be transmitted from different satellite locations along the trajectory.

For each time the reference signal is transmitted from the satellite 141, and the UE 1 is in range and capable of receiving the reference signal, the UE 1 may determine a time of reception Tₖ in the UE 1 of the reference signal at that occasion, where k refers to the k^{th} reference signal. In various scenarios, the exact location of the satellite 141 is not known to the UE 1, absolute time of transmission from the satellite is not available. In other scenarios, the absolute location of the satellite at the time of transmission may have been broadcasted, such as in the Ephemeris, and is thus known. The method proposed herein is still applicable since the exact location of the UE 1 is unknown. Higher accuracy may be attained if absolute satellite locations are considered. Nevertheless, the period τ_{P} is known, and therefore the propagation time difference Δₖ of the reference signal between different occasions, such as successive occasions Tₖ, Tₖ₊₁, can be determined. The propagation time difference Δₖ represents a difference-of-time-of-flight, as can be defined as Δₖ=Tₖ₊₁−Tₖ−τ_{P}, since the occasion k+1 refers to transmission of the reference signal from the satellite 141 τ_{P} seconds later than transmission of the reference signal of occasion k. It may be noted that the propagation time difference may be defined between any pair of occasions, and not necessarily successive occasions, wherein a correspond number of periods τ_{P} are subtracted. The propagation time difference may thus be given by a difference in the time of reception between a later occasion Tₖ₊ₘ, and an earlier occasion Tₖ, subtracted by a difference in time of transmission based on said period τ_{P}.

Trajectory information of the satellite 141 is known to the UE 1, for example by being pre-configured, or obtained by system information, and/or identified in or based on access node identification obtained from the reference signal or another signal received from the satellite 141. The satellite information may include, or identify, the speed and the altitude of the satellite 141 in its trajectory. This may be referred to as Ephemeris. Based on the trajectory information, the travelled distance of the satellite 141 between reference signal transmissions is known to the UE 1. Based thereon, it is here proposed to use standard techniques to compute the distance between the UE 1 and the satellite by determining a relative position with respect to the satellite trajectory at any given time, such as in relation to one or more positions of the satellite 141 at the time of its reference signal transmission.

FIG. 4 schematically illustrates an overview of measurements and computations according to a general presentation of the proposed solution. In this example, we assume that 6 satellite positions are used, i.e. the calculations are based on 6 occasions of receiving the reference signal in the UE 1. The propagation time difference value Δₖ correlates with the difference in distance from the UE 1 to the locations of the satellite 141 at time k and at time k+1. Since the relative distance of the satellite position between time k and time k+1 is known, the value Δₖ defines a spatial condition for the UE 1. The spatial condition may be identified as a hyperbolic condition, wherein Δₖ specifies a hyperbola Hₖ on which the UE 1 must lie. Note that the reference frame for Hₖ is given from the reference direction of the satellite's trajectory and its position at time k=1.

FIG. 5 graphically shows a 2-dimensional projection, e.g. at sea level, of an example of the hyperbolas Hₖ, determined based on the example of FIG. 4. For two occasions, a first hyperbola H₁ may be specified, wherein the only conclusion that can be drawn is that the UE must be located somewhere on that first hyperbola H₁. However, when yet another occasion is considered, a second hyperbola H₂ may be specified, on which the UE must be located. Specifically, an intersection may be identified between two or more hyperbolas, representing a hyperbolic spatial condition based on different sets of occasions. In the example of FIG. 5, six occasions of reference signal reception in the UE 1 are used for identifying five hyperbolas H₁-H₅. If measurement resolution and accuracy is ignored, for the sake of simplicity, all hyperbolas may intersect to identify two positions 51, 52 in this example, in the 2-dimensional projection. In other words, it is possible to determine the position of the UE 1 up to the ambiguity of it being “north” or “south” of the trajectory 53. Note that if the direction of the trajectory would be unknown, then FIG. 5 is randomly rotated. Still, the relative position of the UE 1 with respect to the satellite 141 would be at identified.

While FIGS. 4 and 5 are illustrated for 6 occasions of reception in the UE 1 of the reference signal from the satellite 141, this shall be seen as an example. In certain examples, a parameter value is calculated based on a position which satisfies said spatial condition for a number of occasions, wherein said number is determined based on a control parameter. The control parameter may in various examples be fixed, such as prescribed by a specification, or by the network 100. In another example, it may be specific to the satellite 141, and for example determined based on a look-up table or a calculation formula dependent on information obtained from the satellite 141.

In some examples, the control parameter comprises or is dependent on said period τ_{P} and/or trajectory speed, given by satellite altitude. For shorter periods τ_{P}, the trajectory may roughly be treated as a “straight” orbit during a number of occasions, for which fewer occasions may be required than for a curved trajectory.

In some examples, said control parameter is an accuracy level of the parameter to be estimated, such as TA or Doppler pre-compensation. Again, the accuracy level may be predetermined and fixed, or determined by the UE 1 based on information obtained from the network 100 in general, or specifically from the satellite 141. The parameter value, or only the relative distance or the theoretical positions 51,52, is thus calculated based on an incremented number of occasions until the accuracy level is obtained. For example, if a parameter estimate (or the position or the relative distance), determined by the calculation, changes less than a threshold with a further incremented number of occasions, the calculated parameter value is deemed to be ok to use in communication with the access node of the satellite 141.

As noted, in various examples the parameter is timing advance (TA). Specifically, an initial TA value may be calculated which represents twice the propagation time between the UE 1 and the satellite 141. The initial TA value is employed by the UE in the uplink, based on time of reception of a downlink signal. Specifically, the initial TA is calculated based on the determined theoretical position 51,52 of the UE, and the resulting distance to the satellite 141 at the time of uplink transmission. The distance is thus determined based on the determined theoretical position 51,52 and the time that has lapsed since a reference position of the satellite 141 used in the spatial condition (such as T1) and the known trajectory speed of the satellite 141.

In the context of establishing an estimate of TA according to the methods proposed herein, it may be noted that in various scenarios the satellite 141 may be a transparent satellite, acting as non-regenerative repeater, as outlined in technical specification TR 38.821. In such a scenario, the access node, such as a gNB, can be arranged on the ground, such as ground station 140. In this case, the TA to determine should be between the UE 1 and the on-ground gNB 140, thus including both the link between the UE 1 and the satellite 141 and between the satellite 141 and the ground station. In some instances of this case, however, the on-ground gNB 140 may take care of the satellite-gNB link and it shall thus be understood that the proposed method is still valid for at least part of the total link and useful for calculating a valid TA. The term satellite-based access node 141 shall thus be understood as an access node having its TRP located in the satellite.

It may be noted that, in general legacy operation of both LTE and 5G, it is the access node that computes the TA, and not the UE. The UE may e.g. transmit a random access preamble to the access node, based on which the access node estimates transmission timing correction for the UE and conveys the same to UE using the Random Access Response (RAR) message. This message contains “timing advance command” used by UE to make adjustments in the transmit timing. In various scenarios, the UE 1 may nevertheless be arranged to obtain information that is needed to compute an initial, potentially rough, estimate of the TA. In some examples, this information is encoded in the frequency band used by the UE 1. For example, certain bands are NTN-only bands, and the UE 1 is configured to apply initial TA compensation based on the frequency band. Alternatively, the UE 1 may be pre-configured to determine that initial TA compensation shall be applied based on the frequency of reference signal. In yet another alternative, the access node 141 may be configured to transmit information indicating that UEs shall obtain a rough estimate of the TA before they are allowed to transmit PRACH signals, such as the preamble. This information may for example be broadcast or encoded in the reference signal, as bit(s) of information.

In another example of the proposed solution, the parameter is Doppler pre-compensation, which may be determined using the proposed solution, and subsequently applied to tune or set a frequency for uplink transmission, to accommodate for a frequency shift caused by rapidly changing distance to the satellite 141. The change of distance over time may be determined based on the position 51,52 obtained based on the spatial condition according to the proposed solution, and the time passing between the occasions.

In broad terms, with general reference to the description provided with reference to FIGS. 4 and 5, it may be noted that the corresponding calculations and determination of a parameter may be applied to a 3D scenario. Again, this is based on the satellite 141 travelling along its known trajectory, with a known velocity, wherein the satellite transmits reference signals, e.g. pilots or PRS, with a known time interval between transmissions. According to some examples, the solution is applied in scenarios where the trajectory does not cross the receiver position (as is also the case in FIG. 5). Based on two occasions of reference signal reception the UE 1 can position itself, relative to the satellite 141, limited to a 3D hyperbolic shape. Between further received signals, different hyperbolics can be estimated. The possible relative position between the satellite 141 and the UE 1 becomes limited to the intersection between the hyperbolics (i.e. iso points). For the case the transmitter trajectory is a straight line, the iso points shape a circle of possible positions around the trajectory. When the UE 1 knows the iso points, the UE 1 can estimate the satellite relative distance at any time and therefore compute e.g. the TA, which is the same at any iso point.

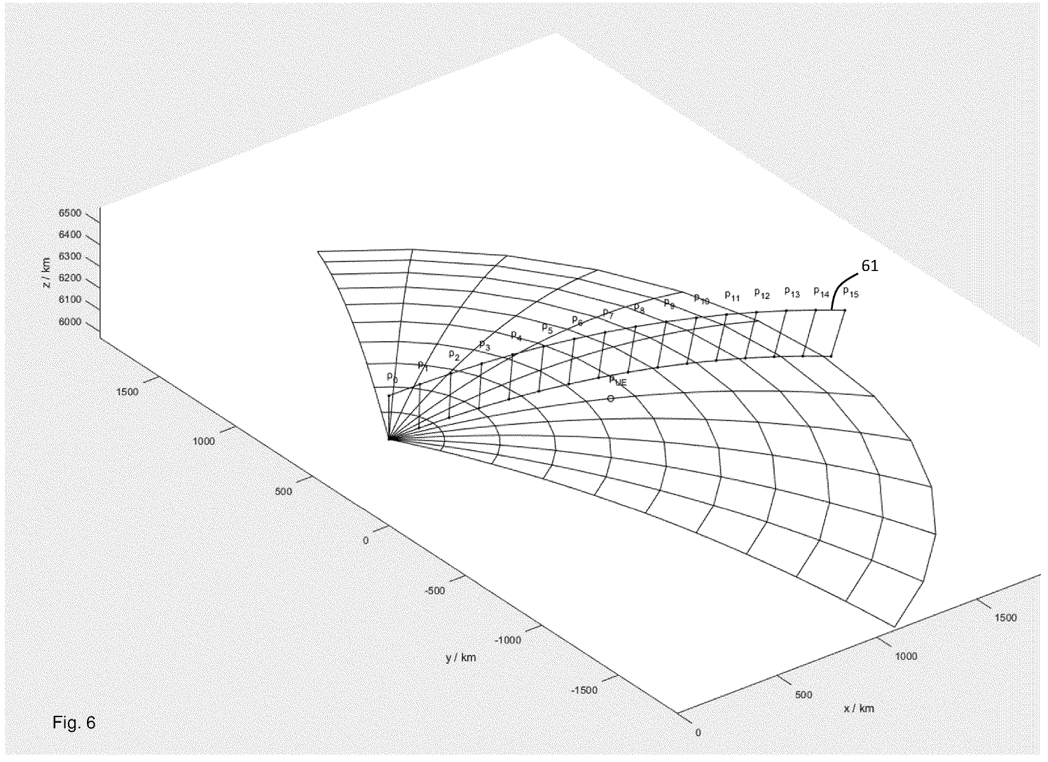

In addition to the general description of the proposed solution as outlined above, a more detailed description the mathematical underpinning of the proposed solution, as outlined with reference to FIGS. 4 and 5, will now be provided with reference to FIGS. 6-9. The following sections serve to provide the reader with a non-limiting example of the type of algorithms and numerical procedures that may be used to implement the ideas disclosed herein.

FIG. 6 illustrates a trajectory 61 which forms a portion of a satellite orbit of a satellite 141 (i.e., an NTN access node or TRP). Let p_{UE}∈R³ denote the position of the UE 1, which is assumed to be static or having a negligible mobility. The NTN TRP of satellite 141 transmits reference signals, alternatively referred to as pilots, from p₀, p₁, . . . , p_{N}∈R³ at times t₀, t₁, . . . , t_{N}, measured in the satellite's 141 time reference, where |tₖ−tₖ₊₁|=τ_{P}. The (comparatively) static UE 1 located at p_{UE} detects the reference signal at times t′₀, t′₁, . . . , measured in the time reference of the UE 1. The satellite 141 follows a Low Earth Orbit (LEO), about 200 km height above sea level and moves at a speed of 7.79 km/s, thus completing the orbit in a bit less than 1.5 hours. In the example, tₙ−tₙ₋₁=20 s and |pₙ−pₙ₋₁|=155.86 km, for all n=1, 2, . . . , N. Note that for illustration purposes, tₙ−tₙ₋₁=20 seconds is used (corresponding to τ_{P}). In current 5G networks, this interval can be as small as 5 ms, or even smaller if the reference signals are transmitted in bursts. The proposed solution is however not limited to any particular value or range of the periodicity.

As noted, the UE 1 knows or is arranged to determine the quantities |pₙ−pₙ₋₁| and tₙ−tₙ₋₁ for any n of interest, based on obtained trajectory information, which may comprise information of the period τ_{P} and the (inter-linked) altitude/speed of the satellite 141.

Assuming line-of-sight (LoS) propagation, the propagation time δₙ of a pilot signal transmitted time tₙ is

$${δ}_{n} = \frac{1}{{c}_{0}} \vert {p}_{UE} - {p}_{n} \vert , \qquad ( A 1 )$$

where |x|=\sqrt{x₁²+x₂²+x₃²} and c₀ is the speed of light in vacuum. For each occasion of reception of the reference signal, the UE 1 detects the reference signal at time

t′ₙ=tₙ+δₙ+Δt, (A2)

where Δt∈R represents a fixed but unknown offset between the time refences of the satellite 141 and the UE 1. From N+1 observation, the following system of N+1 equations may be provided:

$${δ}_{0} = \frac{1}{{c}_{0}} \vert {p}_{UE} - {p}_{0} \vert , \\ {δ}_{1} = \frac{1}{{c}_{0}} \vert {p}_{UE} - {p}_{1} \vert , … , {δ}_{N} = \frac{1}{{c}_{0}} \vert {p}_{UE} - {p}_{N} \vert . \qquad ( A3 )$$

To work around the fact that neither the times t₀, t₁, . . . , t_{N} nor the offset Δt may be known to the UE 1, the first equation in (A3) is subtracted from all the others. Absolute values are then taken to obtain the following N equations:

$$\vert \frac{1}{{c}_{0}} \vert {p}_{UE} - {p}_{1} \vert - \frac{1}{{c}_{0}} \vert {p}_{UE} - {p}_{0} \vert \vert = \vert {δ}_{1} - {δ}_{0} \vert , \\ \vert \frac{1}{{c}_{0}} \vert {p}_{UE} - {p}_{2} \vert - \frac{1}{{c}_{0}} \vert {p}_{UE} - {p}_{0} \vert \vert = \vert {δ}_{2} - {δ}_{0} \vert , \\ … \\ \vert \frac{1}{{c}_{0}} \vert {p}_{UE} - {p}_{N} \vert - \frac{1}{{c}_{0}} \vert {p}_{UE} - {p}_{0} \vert \vert = \vert {δ}_{N} - {δ}_{0} \vert .$$

It may be noted that these equations represent an example where we use δ₀ as reference. In gereral the same weight should be applied to all samplings, e.g. δ₁−δ₀, δ₂−δ₁, δ₃−δ₂ etc.

By defining the positions p′ₙ=pₙ−p₀, p′_{UE}=p_{UE}−p₀ and noting that |p_{UE}−pₙ|=|p′_{UE}−p′ₙ| one can re-write the above N equations as

$$\vert \vert {p}_{UE}^{′} - {p}_{1}^{′} \vert - \vert {p}_{UE}^{′} - {p}_{0}^{′} \vert \vert = {c}_{0} \cdot \vert ( {t}_{1}^{′} - {t}_{0}^{′} ) - ( {t}_{1} - {t}_{0} ) \vert , \\ \vert \vert {p}_{UE}^{′} - {p}_{2}^{′} \vert - \vert {p}_{UE}^{′} - {p}_{0}^{′} \vert \vert = {c}_{0} \cdot \vert ( {t}_{2}^{′} - {t}_{0}^{′} ) - ( {t}_{2} - {t}_{0} ) \vert , \\ … \\ \vert \vert {p}_{UE}^{′} - {p}_{N}^{′} \vert - \vert {p}_{UE}^{′} - {p}_{0}^{′} \vert \vert = {c}_{0} \cdot \vert ( {t}_{N}^{′} - {t}_{0}^{′} ) - ( {t}_{N} - {t}_{0} ) \vert ,$$

which only contain the vector unknown p′_{UE}, i.e., the position of the UE 1 relative to the satellite 141 location p₀. Finally, some algebraic manipulations lead to the hyperboloids

$$\frac{{( {x}_{i}^{′} )}^{2}}{{a}_{i}^{2}} - \frac{{( {y}_{i}^{′} )}^{2} + {( {z}_{i}^{′} )}^{2}}{{c}_{i}^{2} - {a}_{i}^{2}} = 1 , i = 1 , … , N , \qquad ( A4 )$$

where x′ᵢ= [symbol] [symbol] , p′_{UE}−½p′ᵢ [symbol] is the coordinate along a main axis of the i-th hyperboloid in the local reference system, <a, b>=b^{T}a, and y′ᵢ, z′ᵢ are the coordinates on the orthogonal plane to it, and whereas we have defined the unit vector [symbol] =p′ᵢ/|p′ᵢ| from p₀ to pᵢ, cᵢ=½|pᵢ′|=½|pᵢ−p₀| is the semi-focal distance and aᵢ=½c₀·|(t′ᵢ−t′₀)−(tᵢ−t₀)| is the constant of the hyperbola.

Next, it is briefly described how (A4) can be solved. The solution is a set of permissible values of p′_{UE}. Then, the propagation time t_{TA}, based on which for example the estimated TA value can be obtained, is computed as

$${t}_{TA} = \frac{1}{{c}_{0}} \vert {p}_{UE} - {p}_{m} \vert = \frac{1}{{c}_{0}} \vert {p}_{UE}^{′} - {p}_{m}^{′} \vert \qquad ( A5 )$$

for any current or future satellite position pₘ. This is further discussed below.

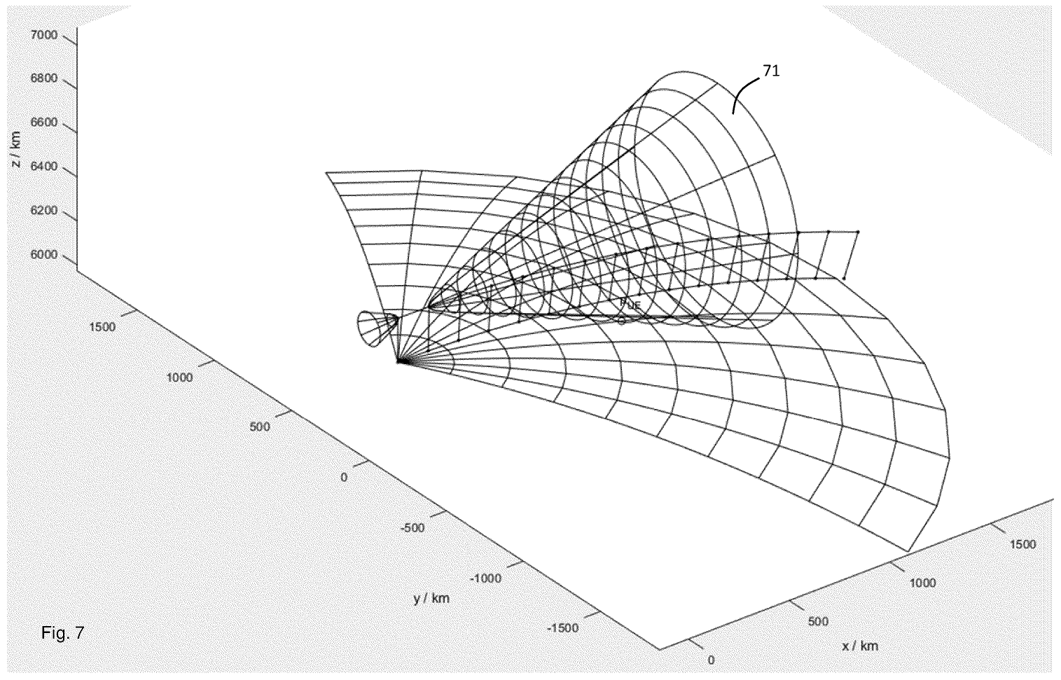

FIG. 7 shows a plot of the hyperboloid 71 obtained based on observations at occasions t′₀, t′₂. The relative location p′_{UE} of the UE is only known up to a surface, i.e. the surface of the hyperboloid 71. Different points on the surface yields different values of |p_{UE}−pₘ|. This can be correlated with the 2D projection of H1 in FIG. 5.

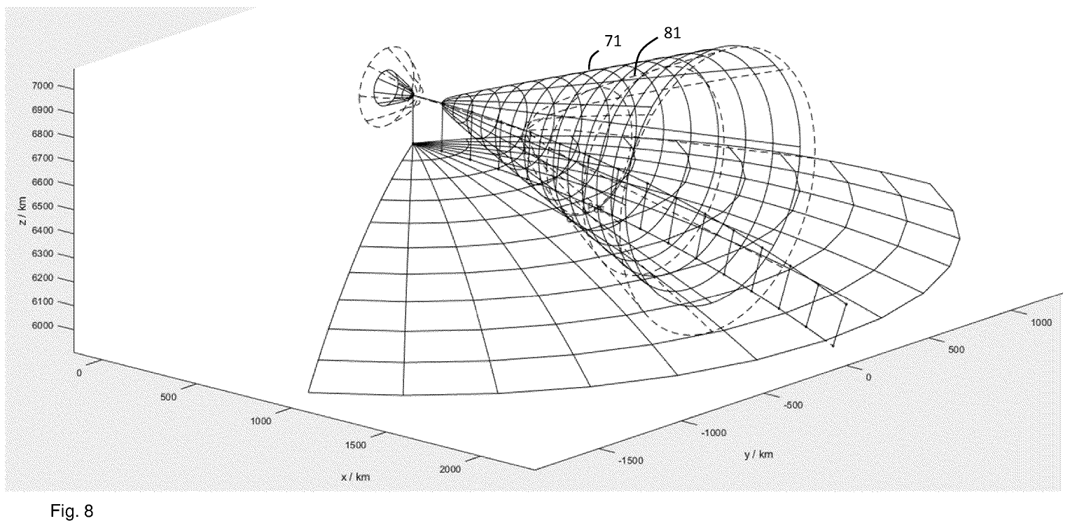

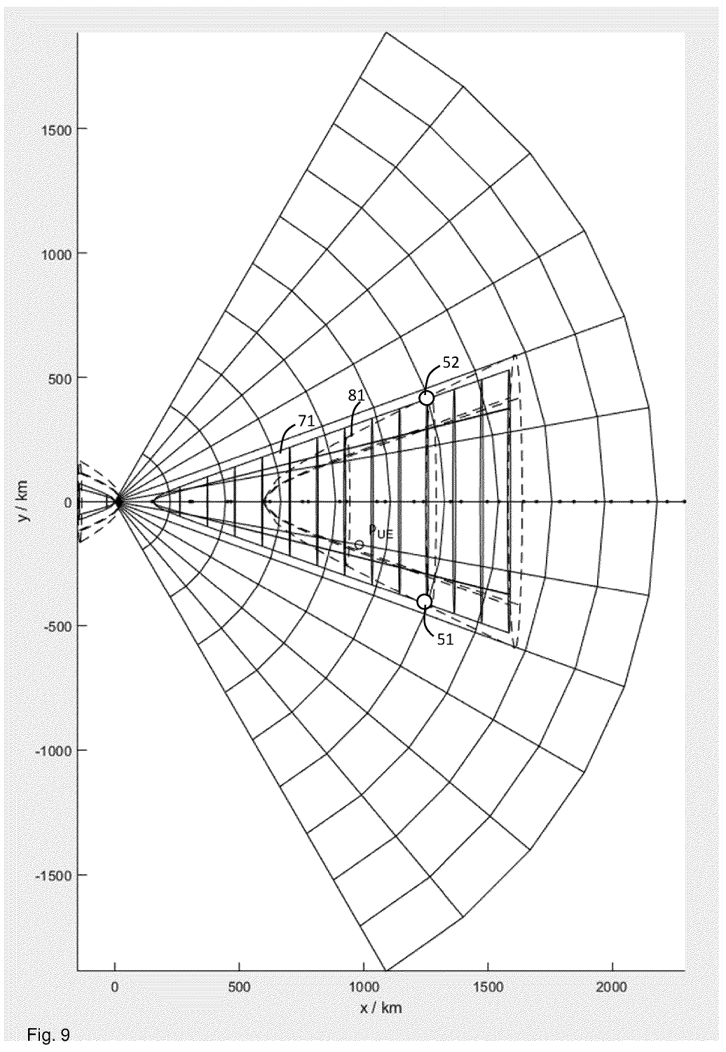

In FIGS. 8 and 9 (2D projection of FIG. 8), an extra hyperboloid 81, corresponding to observations t′₀, t′₅, has been added. It can be shown that the two hyperboloids intersect in a conic section (an ellipse). Hence, the relative location p′_{UE} is now limited to the set of points of the conic section. If a straight satellite trajectory is assumed, the ellipse shape of the conic section will form a circle, on which all points have the same time difference to the satellite 141, rendering the same TA. However, if the curvature of the trajectory is considered, the eccentricity of the ellipse may be larger than one. In that case, the quantity |p_{UE}−pₘ| (and hence e.g. the TA) cannot be determined unambiguously. To determine a theoretical position of the UE 1, which has at least the same distance to the satellite 141 as the UE 1, further information may be required at least when a curved trajectory is considered.

In one example, such further information may be available by means of a measurement or estimate of the height difference between the satellite 141 orbit and the UE 1. In that case, the ambiguity can be reduced to two intersection points of the elliptic intersection between the two hyperbolas 71, 81. As an example, the Earth surface level of the UE 1, e.g. the sea level, may be used as to a further intersecting surface, based on which two points of intersection can be identified, similar to the projection of FIG. 5.

In another example, an extra hyperboloid is used, by taking an additional occasion into account. Conic sections are contained in a plane and the intersection of two planes, in all but rare cases, is a line which, in turn, intersects the hyperboloids at two points yielding the same |p′_{UE}|. Again, corresponding to the general description provided with reference to FIGS. 4 and 5, any of those two points will have the same distance to the satellite 141, making it possible to unambiguously compute the parameter value, such as TA.

A special case may be mentioned. When the reference signal transmission times t₀, t₁, . . . , t_{N} occur sufficiently close to each other, the ellipse resulting from the intersection of two hyperboloids will have an eccentricity close to one, i.e., a circle. Moreover, the intersection of further hyperboloids cannot reduce the circle to a line. However, this is not a problem because all the points in the intersection circle yield the same |p′_{UE}|.

It may again be identified that while the proposed solution does not unambiguously determine the position of the UE 1, the distance to the satellite 141 is nonetheless obtained, based on which for example TA can be determined. In other words, the proposed solution allows proper estimation of TA, and potentially Doppler pre-configuration, to initiate uplink transmissions without needing to know the actual position of the UE 1, as is commonly assumed in 3GPP discussions. Nor are the global positions of the satellite 141 required.

That being said, it should also be noted that our method can be extended to support localization. By using observations from two or more orbits, the position p′_{UE} of the UE relative to p₀ can be obtained. Furthermore, if the NTN-BS location p₀ is known then the global position p_{UE} of the UE can be obtained.

The following table summarizes the minimum required number of occasions of reference signal reception according to various examples:

| Application | Case | Minimum # occasions |
|---|---|---|
| Distance | Straight orbit | 3 |
| (TA, Doppler pre-config.) | Curved orbit | 4 |
| Positioning | Several orbits | >4 |

In the description of the proposed solution outlined above, noiseless measurements have been assumed. Obviously, this is not always realistic, and measurements corrupted by noise need to be considered. This is, however, beyond the scope of this general disclosure of the proposed solution. It suffices to say that the effect of noise may e.g. be targeted by one of using more observations that the minimum required amount given in the table above, and/or using more robust methods to algebraically solve (A4), such as minimum mean -squared error (MMSE) and Bayesian methods.

The proposed solution has been described herein, with reference to various examples. The solution provides a method to estimate a communication parameter, such as TA or Doppler pre-compensation, without requiring any GNSS. This is beneficial both to UEs where low complexity and/or low battery consumption is desired. The proposed solution may also provide the possibility of short access time to the NTN, compared to GNSS-based solutions. The method further relies on only a single satellite trajectory, which means that re-tuning the transceiver of the UE 1 to detect signals from different satellites is not required. Apart from the benefit of the method being more likely to be available than solutions where signals from more than one satellite are required, this may lead to shorter operating time, i.e. low-latency access. In the best case, and assuming a straight line trajectory, three observations are sufficient, which gives a time to fix of down to 2× the transmission periodicity (τ_{P}), and an additional period to transmit in the uplink with an applied initial TA, i.e. 60 ms for a SS-PBCH burst 20 ms typical period. For scenarios where a straight line trajectory can be assumed, Ephemeris becomes limited to satellite velocity, which will be the same for all satellites in a layer. Possibly curvature of the trajectory (i.e. height), which is the same for all satellites in a layer, may increase accuracy.

The proposed solution thus provides a method where neither absolute time nor position of the satellite is needed. Only ranging is needed, not full positioning.

As a final remark, it may be noted that the accuracy of the TA estimate does not always need to be very good. The only requirement is that the UE shall be able to “hit” slots containing random-access occasions at the access node 141, i.e., slot-granularity. The NTN BS can then refine the TA based on received RACH signals from the UE, according to legacy behavior.

The proposed solution has been outlined above with reference to the drawings, and by means of various non-limiting examples. Where not clearly contradictory, the features and modes of operation described herein may be combined in any way as set forth in the appended claims and in the foregoing.

1. A method carried out in a user equipment (UE), for estimation of a parameter of a communication link for use in communication with an orbiting satellite-based access node of a non-terrestrial network, the method comprising:
determining, at repeated occasions, a time of reception in the UE of a reference signal which is transmitted with a predetermined period from the access node; and
calculating a value of the parameter based on a position which satisfies a spatial condition for the UE, which spatial condition is given by a propagation time difference of the reference signal between said occasions.

2. The method of claim 1, wherein the value of the parameter is calculated based on the reference signal as received from a single satellite-based access node.

3. The method of claim 1, wherein said position satisfies said spatial condition based on at least three occasions.

4. The method of claim 1, wherein said position satisfies said spatial condition based on at least four occasions.

5. The method of claim 1, wherein said spatial condition comprises a hyperbolic condition.

6. The method of claim 5, wherein said hyperbolic condition identifies an intersection between a plurality of hyperbolas based on said occasions.

7. The method of claim 6, wherein said hyperbolic condition further identifies intersection between the plurality of hyperbolas and the Earth surface.

8. The method of claim 6, wherein each of said hyperbolas are determined based on a pair of said occasions.

9. The method of claim 1, wherein said position identifies a distance between the UE and the access node.

10. The method of claim 1, wherein said propagation time difference is given by a difference in the time of reception between a later occasion and an earlier occasion, subtracted by a difference in time of transmission based on said period.

11. The method of claim 1, wherein said spatial condition is determined for a number of occasions, wherein said number is determined based on a control parameter.

12. The method of claim 11, wherein said control parameter is dependent on said period.

13. The method of claim 11, wherein said control parameter is an accuracy level of the calculated value of the parameter, wherein number is incremented until the accuracy level is obtained.

14. The method of claim 13, wherein said accuracy level is determined based on a threshold test on a change of the accuracy level, calculated on incremented number of occasions.

15. The method of claim 1, wherein said parameter is timing advance.

16. The method of claim 1, wherein said parameter is Doppler pre compensation.

17. A user equipment (UE), configured for communication with an orbiting satellite-based access node of a non-terrestrial network operation with a wireless network, said UE comprising:
a wireless transceiver;
logic configured to control the wireless transceiver and to estimate a parameter of a communication link for use in communication with the access node, including to:
determine, at repeated occasions, a time of reception in the UE of a reference signal which is transmitted with a predetermined period from the access node; and
calculate a value of the parameter based on a position which satisfies a spatial condition for the UE, which spatial condition is given by a propagation time difference-of the reference signal between said occasions.

18. (canceled)
